(19) United States
(12) Patent Application Publication
(10) Pub. No.: US 2008/0152109 A1
(43) Pub. Date: Jun. 26, 2008

(54) Subscriber Phones Integration Device, System, and Method

(75) Inventors: Eyal Bartfeld, Lexington, MA (US); Giora Keinan, Rishon LeZion (IL); Kyle James Copland, Marlborough, MA (US)

Correspondence Address: LAWSON & WEITZEN, LLP, 88 BLACK FALCON AVE, SUITE 345, BOSTON, MA, 02210, US

(73) Assignee: INTEGRA5 COMMUNICATIONS INC., Burlington, MA (US)

(21) Appl. No.: 11/614,317

(22) Filed: Dec. 21, 2006

(51) Int. Cl. H04M 1/56

(52) U.S. Cl. 379/142.06

(57) ABSTRACT

A major aspect of the invention offers the subscriber the capacity to control one telephone connection from another, and/or from a television, including call diversion and transferring. Preferably this is done utilizing correlation and cross-linking between the various telephone and other devices connections. As in the preferred embodiment the cross-linking is performed primarily at the infrastructure level rather then at the device level, the subscriber enjoys unified telephony environment, as well as call control services from one connection to another.

### FIELD OF THE INVENTION

This application relates generally to telephone call management, and more particularly to supplying Call Management between a plurality of subscriber related phone connections, such as wired connections and cellular connections.

### BACKGROUND OF THE INVENTION

Lately there have been a growing number of communication options offered to users. By way of example, IP (Internet Protocol) based telephones, cellular telephony, computer-based telephony and the like have been added to the plain landline telephony service of old. Thus it is common for a communication user (subscriber hereinafter) to have a plurality of telephone connections, such as one or more cellular telephones, as well as several wired telephone connections, such as a regular telephone, an IP based line, and the like. All those devices are primarily separate, non-related entities, despite the fact that they all connect to a single subscriber.

Most modern telephone devices or services provide some capabilities of call control such as forwarding a call to a different number, diverting the call to voicemail, blocking calls and the like. Some of the modern devices have the capability of listening to voicemail recording while it is being recorded, picking up a call while it is recorded in the voicemail machine, and other call control features. These capabilities are handled differently in different devices and service providers. By way of example, certain devices divert a call to voice mail by diverting the call to a voicemail machine (VM) at a remote site, while other devices may divert the call to be recorded locally within the device.

Service providers have several options for providing the services to the subscriber. Common options utilize TDM class 5 switches which are usually connected to analog telephones, and IP-based switches which are generally used in newer telephony networks. A variety of physical connections such as analog line, ADSL, cable, wireless, fiber etc, and a variety of IP telephony protocols such as SIP, H323, MGCP, MEGACO etc. are also used.

U.S. published application Ser. No. 10/189,269 published as US patent publication No. US-2003-0086432 on May 8, 2003 to two of the present inventors, discloses a system for telephony call control via television, applicable especially when a close cooperation exists between the telephony provider and the television provider. U.S. published application Ser. No. 10/870,613, published as US-2004-0261115 on Dec. 23, 2004 to one of the present inventors, provides for control of a VOIP based device using a television. However at present there is no known solution that allows one communication channel to control communications in another communication channel. Data exchange, controlling, and providing call management services of one telephony associated connection from another telephony associated connection, is also sorely lacking.

It would have been desirous for a subscriber to be able to control and/or manage one of those telephony connections or its associated device from a different telephony connection, and to facilitate such control to provide data exchange capabilities between the connections. Different aspects of the present invention, separately or in combination, provide such capabilities.

### SUMMARY OF THE INVENTION

In one aspect, the invention offers the subscriber the capacity to control one telephone connection from another, and/or from a television. Preferably this is done utilizing correlation and cross-linking between the various telephone and other devices connections. As in the preferred embodiment the cross-linking is performed primarily at the infrastructure level rather then at the device level, the subscriber enjoys unified telephony environment, as well as call control services from one connection to another.

Thus in the most preferred embodiment of the invention, the subscriber is given an option to control phone lines and certain communication parameters associated therewith from another phone line in the system, to receive notification when a new call or Voice Mail is received by a different line.

By way of example, in the preferred embodiment the subscribe may receive a notification on his Cellular phone that a new call was initiated to his home landline telephone. The subscriber receives information regarding the identity of the caller, and can redirect the call to the cellular phone. He can divert the call to a voicemail and then if desired listen to the message while it is being recorded. The subscriber may pick the call from the VM. If the call was answered at the home, the subscriber can join the call as a conference call. Similar options may be available from the subscriber home phone line—directly or using another device such as a television set as controlling device. Various embodiments of the present invention are directed to any combination of such features.

In these specifications the terms phone, telephone, telephone line, and telephone connections are used interchangeably. Similarly, cell phone and mobile phone are used interchangeably. A TV implies a television and an STB implies a set-top box, i.e. a device used to interface a television with a television distribution network, having at least some control capabilities to provide selection of the displayed content, like channel selection, and the like. Set top boxes may be stand-alone devices or may be integrated into televisions. As in most preferred embodiments the television/set-top box combination are used in close conjunction, the terms television and set-top box/STB are often used interchangeably, and often one is used to describe the combination of a television and a set-top box. The term ‘agent’ is used to denote generally a capability installed or embedded in a device, by hardware, software, or a combination thereof, that allows it to perform the required functionality described. The skilled in the art will recognize that the construction of such an agent is within the capability of the skilled artisan, and that due to the overwhelming number of possible variations of implementing such, the specific implementation method is a matter of technical choice and would not be overly detailed.

Thus there is provided in one aspect of the invention, a method for routing incoming telephony calls between a plurality of telephony connections, each connection comprising at least one telephony capable end device, the method comprising steps carried out in a call control server. The steps comprise receiving information about an incoming call directed to a first end device; using information associated with the first end device, extracting information from a database. The information comprising at least one rule and information about at least a second end device. Formatting at least one message containing information regarding said incoming call, into a format compatible with said second end device, and transmitting said message to said second end device. Then, receiving a divert request from said second end device; and, taking action to redirect said incoming call in accordance with said divert request.

Preferably, in the step of extracting, the information comprises a plurality of end devices. The step of transmitting may be performed for at least two of said plurality of end devices.

While in then method above is directed to using a database that may be either in the first end device or remote thereto, the preferred embodiment utilizes a database which resides in a location remote to the first end device.

Further preferably, the action is taken at least in part, at a telephony switch. However in the most preferred embodiment, the action or a portion thereof, is initiated at said first end device.

In yet another aspect of the invention there is provided a method for routing incoming telephony calls between a plurality of telephony connections, each connection comprising at least one telephony capable end device, the method comprising the steps of, in a call control server: receiving information about an incoming call directed to a first end device; using information about said first end device, extracting information from a database, the information comprising at least one rule and information about a plurality of other end devices; formatting at least one message containing information regarding said incoming call, into format compatible with at least a second end device selected from said plurality of end devices, the message containing sufficient information to allow said second end device to take action to divert said call.

Preferably, the action to divert the call is initiated by said second end device, and is carried out at a telephony switch remote from the second end device.

Another aspect of the present invention provides for a telephony call control server comprising an incoming call information receiver, constructed to receive call information regarding an incoming call from a plurality of telephony networks and/or from a plurality of network types, said information including at least identification of a first end device; a database manager, constructed to extract from a database related information associated with an incoming call, according to said identification of said first end device, said related information comprising identification of a plurality of other end devices associated with said first end device; a message formatter, constructed to format a message containing at least said call information, in a format compatible with at least a second end device, selected from said plurality of end devices; and a message transmitter capable of transmitting said message to said second device.

Preferably the call control server further comprises a diverter capable of receiving a divert command from said second end device, and initiate action to divert said incoming call in accordance with said divert command.

### SHORT DESCRIPTION OF DRAWINGS

FIG. 1 depicts a simplified environment suitable for operating a call control in accordance with the present invention.

FIG. 2 depicts an overview of the logical structure of the system and its environment in accordance with the preferred embodiment.

FIG. 3—depicts a detail description of the Call Control Server in accordance with the preferred embodiment.

FIG. 4 depicts an example of a flow diagram of a call to a cell phone diverted to landline using a TV/STB as the control device. The call control server is communicating with a cell switch.

FIG. 5 depicts an example of a flow diagram of a call to a Cell Phone Diverted to Landline using a TV/STB as the control device, where an agent in the cell phone is utilized. FIG. 6 depicts an example of a flow diagram of a call to a landline phone diverted to a cell phone using cell phone control.

FIG. 7 depicts an example flow diagram of a conference call creation, initiating from a cell phone, and connecting to a call that was originally initiated to a landline phone.

FIG. 8 depicts an example flow diagram of listening to a voicemail message as it is being recorded, where the initial call was directed to a landline telephone.

FIG. 9 depicts a preferred embodiment of the TRX Coupling Device.

### DETAILED DESCRIPTION

In order to assist the understanding of the invention, preferred embodiments will be described in detail below. The described embodiments contain several optional features and those should not be construed as mandatory. The skilled in the art will also recognize that the environment depicted is but one configuration in which the invention may be practiced, and that the invention may be exercised with fewer or more of the parts and connections described herein, and that the specific configurations described are provided by way of non-limiting examples to enhance understanding of the inventor's contribution.

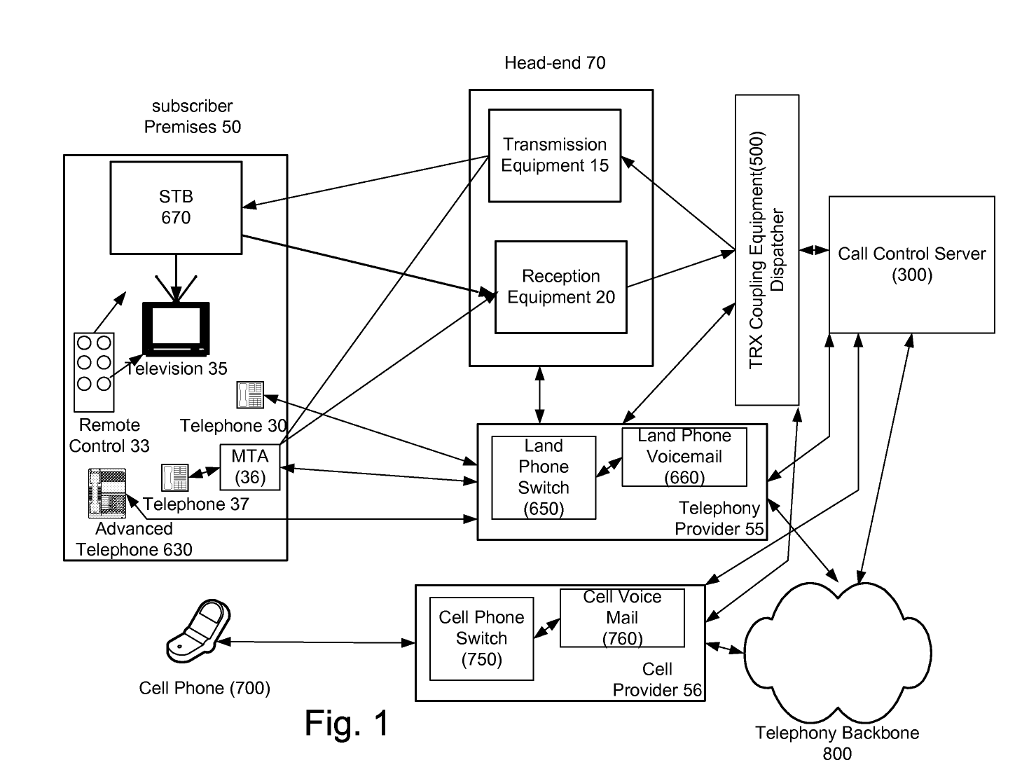

FIG. 1 depicts a simplified environment suitable for operating a Call Control Server (CCS) 300 and the methods described herein. The Telephony network 800 is coupled to a telephony provider 55, which may, for example, be a common carrier company, a cable company, or any other provider of telephony services to the user premises. The telephony network may also be coupled to a cell provider 56, which provides cellular telephony services to the subscriber. The telephony provider and the cell provider may be the same provider, or different entities.

Telephony provider 55 and Cell provider 56 utilize a messaging system, preferably a unified messaging system, but any voice capable server will suffice. Land phone switch 650 couples between the Telephony network 800, and a voice messaging system such as the land phone voicemail system 660. In case that the MTA 36 (Multi Media Terminal) is connected to the cable network (i.e. voice over cable), the land phone switch also couples to a television network center, known as a headend 70. The switch 650 is preferably an IP-based or Voice over IP (internet protocol) switch, also known as softswitch however the invention may operate with various switch types, such as a class 5 switch, an SS7 switch, and the like.

In a somewhat similar fashion Cell Phone Switch 750 couples between the subscriber cellular phone, the telephony network 800, and the Cell Voice Mail 760. Notably, the cellular voice mail system and the land phone switch may be embodied as a single voice mail system, or as separate units, and may either be operated by the respective provider or by a different entity.

The headend 70 includes Transmission coupling equipment 15 and Reception Equipment 20 that are used to send and receive information to and from the user television set 35, and Set Top Box (STB) 670. Optionally the headend also couple a subscriber telephone 37 via an MTA (Multimedia Terminal Adapter) 36. The communications between the headend and the subscriber premises is carried out via the distribution network.

CCS (Call Control Server) 300 is coupled to the telephony network 800 and/or to the telephony provider 55 and to the cell provider 56 for receiving call information and controlling calls. The CCS is also coupled to the Head-end and/or the telephony provider equipment 55 and/or the cell provider equipment for sending and receiving messages from the subscriber devices as dictated by the communicating devices, the communicating equipment, or the network.

Examples of end user devices / equipment may comprise any combination of Telephone 30, MTA 36 and Telephone 37, Advanced Phone 630, and Cell phone 700. In these specifications, IP based phone are treated similarly to the combination of an MTA and Telephone. The advanced phone is a phone having software driven capabilities, with or without a display, and may be a line phone, or an IP based phone, Remote control 33 may be used for controlling the television or the Set-Top Box, to act as an input device and allow either the television, the STB, or an STB combined in the television to act as yet another end user device.

While the description above provides a variety of desired system components and their desired inter-relations, the skilled in the art will readily recognize that other embodiment may use fewer or more components depicted in this description, but still be equivalent thereto, and fall the scope of the invention.

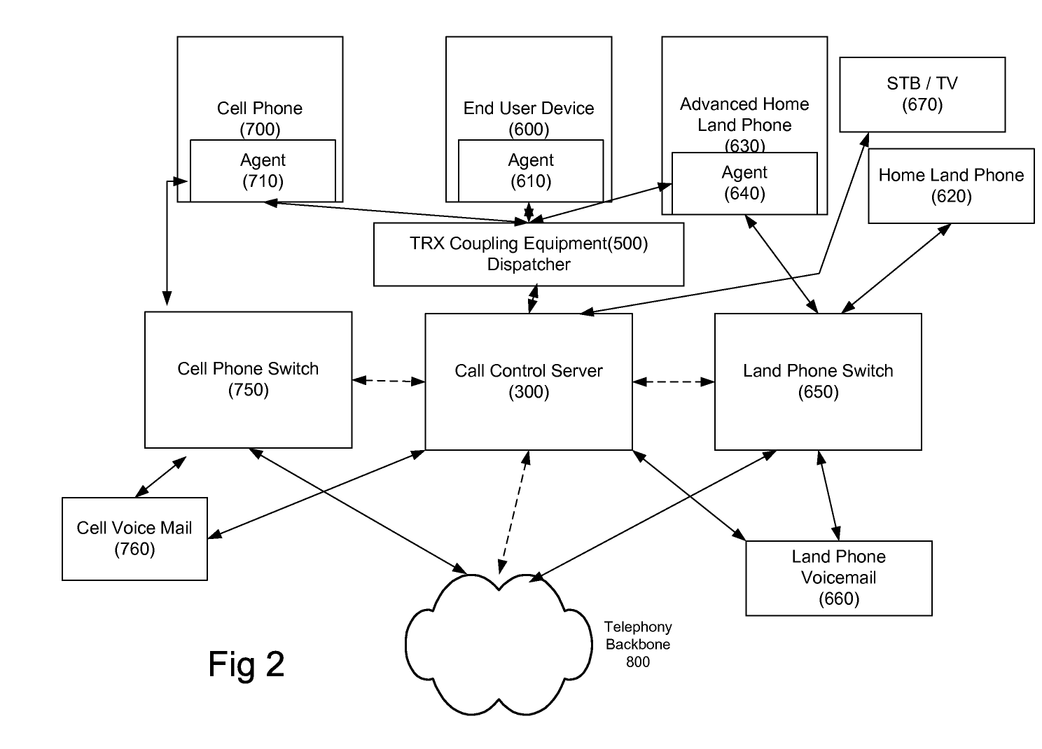

FIG. 2 depicts a logical overview of the system and its environment in accordance with the preferred embodiment. The subscriber in this case has at least any two of the following end devices: a cellular phone 700, a simple landline phone 30 and an advanced phone 630. The simple landline phone may be either an IP, or regular telephone line based device and need not have any software based capabilities. The Advanced phone is a phone with software capabilities for example PC (Personal Computer) base phone.

Preferably, a television set coupled to a set-to-box (STB) 670 is used in association with at least a simple phone, as a control device for the phone and system operation. The STB may be integrated into the television or separate therefrom. Preferably a remote control operates the television and/or the STB as desired.

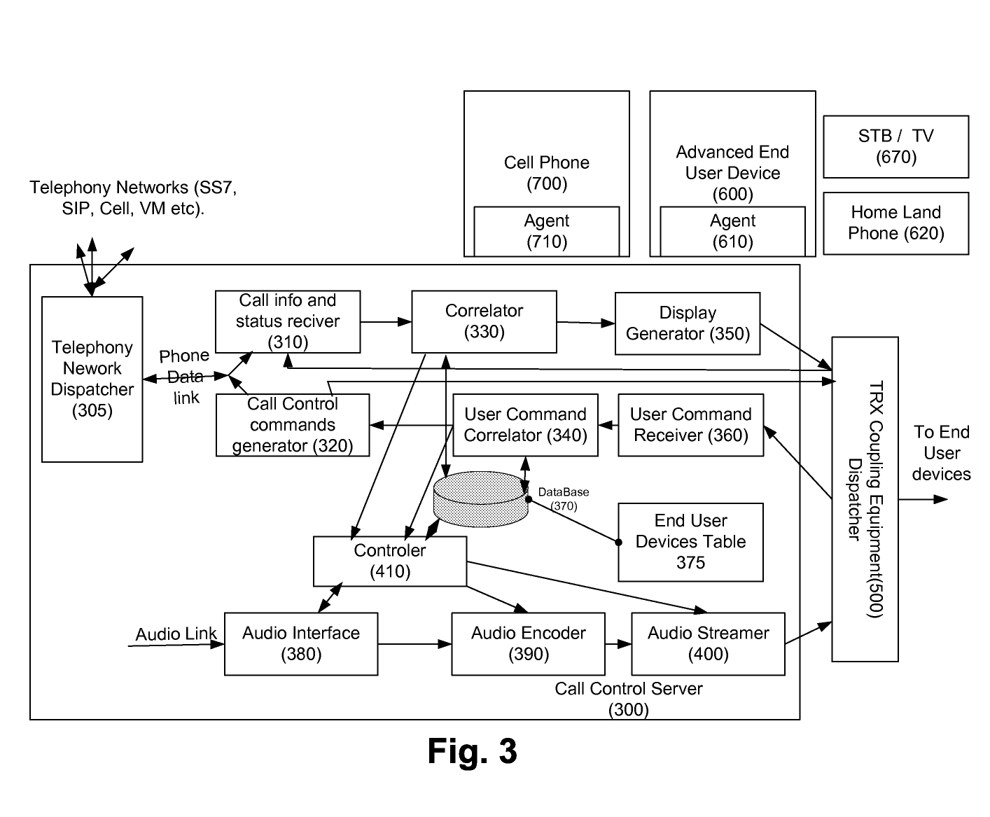

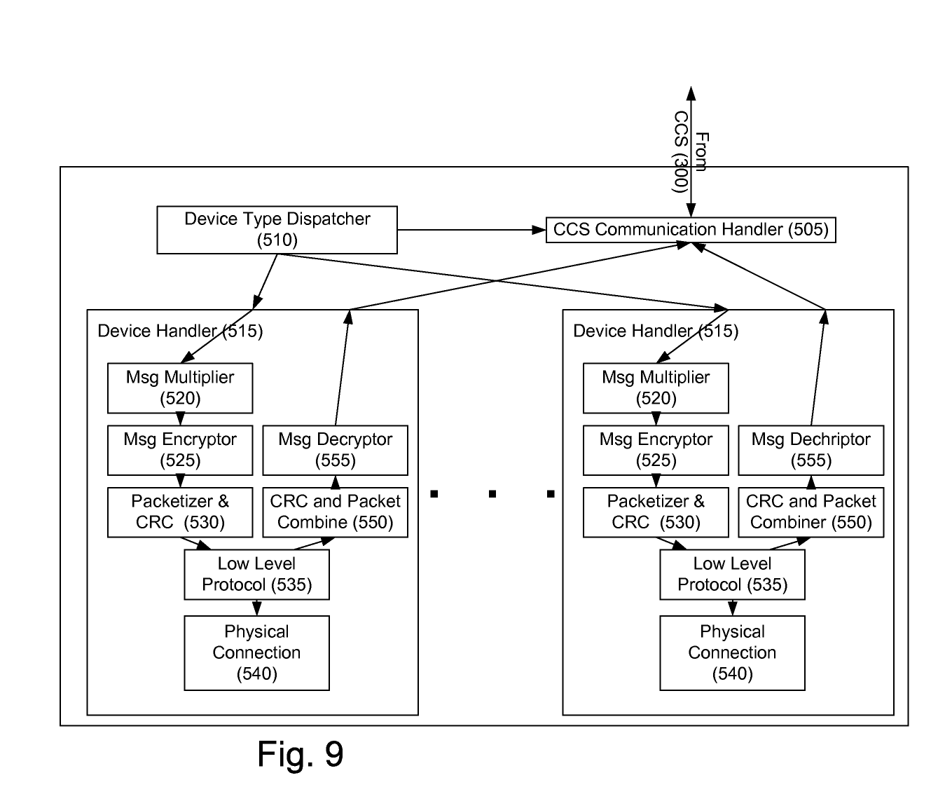

FIG. 3 depicts the Call control server 300 receives information from subscriber devices. The information can be received directly from the end devices using agents in the devices, from the phone switches connected to the respective device, directly from the telephony network, or any combination of the above The TRX Coupling Equipment 500 which is logically a part of the CCS 300 is the component that is responsible for routing the information to and from the end devices using the appropriate protocol (TCP, UDP, MPEG, . . . ) and physical connection (Ethernet, Cable in band or out of band transmission landlines, and the like). TRX Coupling equipment 500 also handles low level communication tasks such as packetizing, calculating CRC, handling retransmissions and the like. If a single message should be sent to several devices, the TRX coupling equipment 500 may also duplicate and transmit the message to all of those devices. The TRX transmission coupling equipment is largely dependent on the broadband network type, equipment, and configuration. Preferred embodiment of the TRX coupling device is described in FIG. 9.

FIG. 3 depicts in more details a preferred embodiment of the Call Control Server 300 (CCS). The preferred embodiment of the call control server is a general purpose computer equipped with software and hardware combination allowing it to perform the required functions. However it is noted that the CCS may comprise a special purpose computer, or a plurality of computers in a large number of combinations or configurations, as will be clear to the skilled in the art. Each of the modules depicted may be implemented by hardware, by software, or by a combination thereof, and may be located in one computer or distributed between a plurality of computers.

The telephony network dispatcher 305 communicates with the telephony network, and/or with telephony switches using various telephony protocols. This module performs two main tasks. The first one is to communicate with the telephony switches and networks using the proper physical connection (such as T1, E1 Ethernet, or any appropriate wired or wireless link and protocols (such as SS7, SIP, MGCP, MEGACO, H323 or any other communication protocol). The second task performed by the telephony network dispatcher is to maintain a call session in case the CCS is connected to more than one telephony switch, meaning that a command that is related to a call will be sent to the particular switch that is handling the call.

Call info and status receiver 310 is coupled to the telephony network dispatcher 305 and to the user command receiver 360. It receives call information from the telephony network dispatcher, and VM messages from a voice-mail server. The Call info and status receiver 310 parses all messages and transfers the parsed information to the coupled correlator 330 in such a way that messages will be in the same context as messages source. The Corralator is coupled to the controller 410 and to the database 370.

The database contains an end user devices table 375. The table contains the required information about devices. Examples of information about devices are: address, type, capabilities and the like. The table can be stored in one table, in plurality of tables or by any convenient method. This information typically does not get changed during calls, although exceptions may happen.

The controller 410 maintains dynamic information regarding the current call progress states of end user devices (preferably internally or inside the database). It is using the current state and the information received from all the coupled modules in order to select the appropriate message or command that will be sent to other modules. In addition, the controller progresses the end user device to the next state. Alternatively, a stateless controller may be utilized. Using this option, the end user equipment may send its current status embedded inside the messages that are sent to the CCS.

The corallator 330 uses the received message, the list of the end user equipment data and the current state of the end user equipment, in order to generate a logical message to the display generator 350. The display generator generates a UI (User Interface) message and call control messages (such as divert) that are suitable for display on the end user device type and sends it the coupled TRX Coupling Equipment Dispatcher 500. The “displayed format” can be a logic command which the end user device can display, a list of graphic primitives, an XML or a HTML file, or any other appropriate format which will cause the message, and optionally response triggers, to display on the selected end devices.

The user command receiver 360 is coupled to the TRX coupling equipment dispatcher 500 from which it receives command from the end user equipment. Its output is connected to the user command controller 340 and to the Call info and status receiver 310. The user command receiver parses messages received from the end user equipment and translates messages from varied end user devices into a uniform format. If a received message contains call information, it is transmitted to the call information and status receiver 310. If the message contains user commands it is forwarded to the user command controller 340.

The user command controller 340 is coupled to the display generator 350 and to the call control commands generator 320. It is also connected to the database 370 and to the controller 410. When a message is received the user command controller 340 gets the list of the end user equipment from the database 370, ascertains the state of the end user equipment from the controller 410, and uses the state information to generate a call control command or a UI command, as needed. The command is then sent to the telephony network via the telephony network dispatcher 305 and the phone data link 307, or to the display generator in order to be sent to one or more end user devices. It should be noted that most commands sent by Controller 410 will be sent to telephony devices. However controller 410 can also send commands to other devices as well.

The Call control commands generator 320 is coupled to the Telephony network dispatcher using the phone data link. It encodes the command received from the user command controller 340 and sends the output to the Telephony network dispatcher 305.

Audio link 385 comprises any number of audio feeds to the system, from the like of the telephony network, a cellular network, internet, intranet, and the like. The Audio link may utilize any convenient link, such as T1, Ethernet, wireless, and the like. The audio interface 380 is a device that appropriates communication protocols to the network on which these protocols are deployed. It is coupled to the audio link 385 and to the Controller 410, and to the Audio Encoder 390. The audio interface role is to receive the audio from the appropriate audio link (such as T1 channel, UDP port and the like) using the interface appropriate to the link. The Audio Encoder 390 receives the audio from the audio interface and encodes it into an audio format suitable for various target end user devices. In cable networks the formats commonly used are MPEG or AC3. Audio encoder 390 is coupled to the audio streamer 400 that streams the audio through the TRX coupling equipment dispatcher 500 to the appropriate end user device. The controller 410 controls all the streaming modules (380, 390 and 400). The controller 410 also utilizes the database in order to receive the end user device capabilities. It further uses the end user device state if available and control the audio interface so it will receive the data from the proper audio link. The Controller 410 further controls the audio encoder 390 so that the audio will be encoded into the right audio format. The Controller 410 further controls the audio streamer 400 so that the audio will be sent to the right end user device using the appropriate communication protocol.

FIG. 9 depicts a preferred embodiment of TRX Coupling Device. CCS Communication Handler 510 dispatches messages according to the target device type. Device Handler 515 handles the communication with devices. It has logic to detect the type of the destination device and to construct the messages sent to that device accordingly. More than one instance of a Device handler may exists in order to handle devices that may be substantially different one from each other. Message Multiplier 520 is used in those cases where the same message needs to get sent to more than one device of same type. For example, in those cases where several set-top boxes of same type needs to get alerted, the Message Multiplier is responsible to duplicate and send essentially the same message to those devices. The list of devices is received from CCS 510. Message encryptor 525 is used in those cases where message encryption is needed. Packetizer and CRC unit 530 splits the message into more than a single IP packet if needed, and calculates CRC. Packed size and CRC calculation may be a requirement of a particular delivery network. Low Level Protocol unit 535 handles the low level protocol implementation. Examples for low level protocols include TCP, UDP, MPEG and the likes. Physical connection unit 540 is handling the physical connectivity to networks. In a preferred embodiment of the invention this is expected to be Ethernet, but other access networks may be used. For example, ASI for cable TV network connectivity. CRC and Packet combiner 550 calculates CRCX and combines several packets to a single message, as may be needed. Message Decryptor 555 decrypts a received message.

### General System operation

The general operation of the system according to the most preferred embodiment is described below.

The call control server receives information regarding incoming calls to each of the registered end user devices. The incoming call information arrives from communication service providers like cell provider 56, telephony provider 55, via the telephony network 800 such as by SS7 billing and control links, from agents in the end user devices, or in any other convenient manner. Upon receiving the incoming call information, CCS 300 identifies the subscriber for which the call arrived, and correlates the incoming call with a plurality of end user devices associated with this subscriber, such as cell phone, landline phone, IP based phone, and the like. Using a combination of rules and state information for those devices, and optionally user preferences, the CCS forms messages to the plurality of devices. Each of the messages is formed in a format usable by the target device. The CCS dispatches those messages via the TRX coupling equipment 500 to the appropriate devices using a protocol usable by the target device. The end user devices inform the subscriber of the event. The end user can elect from several options such as: pick up the call at any device, even if it was directed to another telephony connection, direct the call to either central or local voicemail at any of the associated end user devices, join in a conference call with the call if answered by another telephony connection, listen to a VM message as it is being recorded, pick up a call while a VM message is being recorded, and the like.

After the user selected the desired action, the selection is conveyed back to the CCS, which acts upon the selection. The CCS generates appropriate commands to one or more devices, the network, switches, VM systems, and the like, as required to perform the requested action. The generated commands are delivered to the appropriate components, either internal to the system such as the CCS, or external such as the service providers 55, 56, and 70. If required, the CCS awaits responses or confirmation from the various system components, and then acts or initiates additional commands. The command/response sequence may be performed several times till the required operation is done.

Optionally, the system provides for other features initiated by the user, such as redirecting a call from one device to another device, or configuration of one device from another device. Those features are again accomplished by communications between the end user devices, the agents in such devices, cell and land line switching equipment and facilities, and the telephony network as a whole. The CCS 300 receives communications in different formats such as SS7 messages, Ethernet packets, voice, streamed voice, control messages and the like from the plurality of sources, and coordinates system operation. The CCS maintains data about the plurality of end user devices associated with a subscriber. The CCS is adapted to translate messages from several sources and of several formats, and dispatch messages and commands after they have been translated to a format suitable for the target device. The CCS is also capable of responding to user commands, and initiates a series of actions through one or more devices to cause the desired behavior.

Alternatively, the information originating at any or all of the cell, landline or other telephony switches may be detected from the telephony backbone, i.e. the underlying telephony network 800. Doing so obviates the need for direct communication between the switch and the CCS. This can be carried out by the like of SS7 signaling channels, and the like. Clearly, the gathering of such information from the telephony network allows system operation without a pre-arranged agreement of any specific service provider, as all providers are bound to the telephony network protocols to ensure inter-operability. Thus any combination of methods to receive the call related information is considered, and many of the commands handed down to switches may also be sent directly through telephony network protocols.

Call Diversion may be carried out in one of two main methods. The first method calls for sending divert commands to the telephony switch (650, 750), while the second method is based on diverting the call by an agent located in the end user device, using the end user device capabilities. An example for call diversion in SIP (Session Initiation Protocol) end user device a “Moved Permanently” or “Moved Temporarily” responses may be used, as described in RFP 3261.

An additional Call Diversion method may be used if the end user devices have certain software capabilities, such as provided by way of example, by advanced phone 630 or cell phones 700. During initialization the agents (640 and 710) in the devices, retrieve the end user device information from the database 370 in the CCS 300. The information can comprise a phone number, an IP address, a URL, or any other addressing mode, and it can further contain the device capabilities. When a new call is received in one device the device sends the new call information directly to the second device. If the user of the second device wishes to divert the call from the first device to the second, the second device sends the divert request directly to the first device which subsequently diverts the call.

### General Operational Features

As the present invention provides many optional features and modes of operation, some general features will be described, followed by more detailed examples showing events flow of how those optional features, as well as other features, are accomplished in the preferred embodiments.

In one mode of operation, a new call is initiated to one of the telephone lines. A new call information is received from the switch (650, 750) respective to the connection type, from the Telephony network 800 or from the agents (710, 610, 640) located inside the end user devices (700, 600, 630). The TRX (Transmit/receive) Coupling Equipment (500) may be used in order to dispatch the required information to the appropriate device using the appropriate communication protocol. The TRX Coupling Equipment (500) may also be used to receive information such as new call and subscriber selection from agents located in the end user devices.

In yet another embodiment of the invention, when a new call arrives to Cell Phone 700, agent 710 sends the new call information o the CCS 300 via the TRX Coupling Equipment 500. The CCS generates new call messages to any or all the subscriber's relevant devices—600, 630 and 670, according to the selected preferences. The same new call information an be sent from the Cell phone switch 750, In which case the call agent 710 is not required.

### Description of Session Specific Examples

In order to increase the understanding of the person wishing to implement different aspects of the invention, the following detailed session description examples are provided. The examples are provided to increase the understanding of implementation methods and of operational logic of the invention, rather than as limitations that are either required by the system or limits system boundaries.

An optional feature allows the subscriber to affect certain call control features for a call received in a first telephone connection, from a second telephone connection. By way of example we assume that the subscriber received information on a first end user device that a new call arrived at the second end user device. The subscriber initiates a control command from the first device, which is sent to the Call Control Server 300 by the agent in the first device (or by the agent executed on the STB 650 associated with the Home landline phone 620, if it is the first device)

The server performs the control command by sending control commands to the phone switches, or to the appropriate VM machine, or by sending commands to an agent in the second device.

If the subscriber issued a command requesting to listen to a voicemail while it is being recorded, the Call Control Server 300 sends a command to the appropriate voice mail system 660 or 760. The audio from the voicemail is then sent to the first end user device using the phone system network or by streaming the audio to the first device. In yet another alternative, the subscriber may issue a control command that causes the audio to be streamed to a third device, such as an STB, in case that the subscriber wants to listen to the recorded VM message using the television set. In this case the Audio interface 380 the audio encoder 390 and the audio streamer 400 are used the stream the audio to the STB.

If the subscriber wants to pick up the call to the second device, the agent in the first device (or the STB) sends an appropriate command to the Call Control Server (300). The Server than send a divert command to the first phone switch and a stop conference / streaming to the VM system. In response the first phone switch diverts the call from the VM system to the subscriber's second device. Optionally, the caller receives notification of the transfer.

When the user selects a command (cancel, listen or pickup) the user command receiver 360 parses the data. If needed, it queries the user command correlator 340, which gets the subscriber phone numbers form the data base 370 or from the controller 410. If the nature of the commend dictate (e.g. listen), the user command receiver sends a command to the call control commands generator 320 which generates a command (Listen or Pickup) and send it to the phone network using a protocol appropriate to the system involved. This can be done using the Telephony Network dispatcher (305) or by sending the command to the agents (610, 710) located on the end user devices via the TRX Coupling Equipment (500). When the user selects the Pickup option, the controller commands the Audio streamer to stop transmitting the audio. The controller 410 is responsible for synchronization between the two directions of the data link and the audio link, and for managing the subscriber session as required.

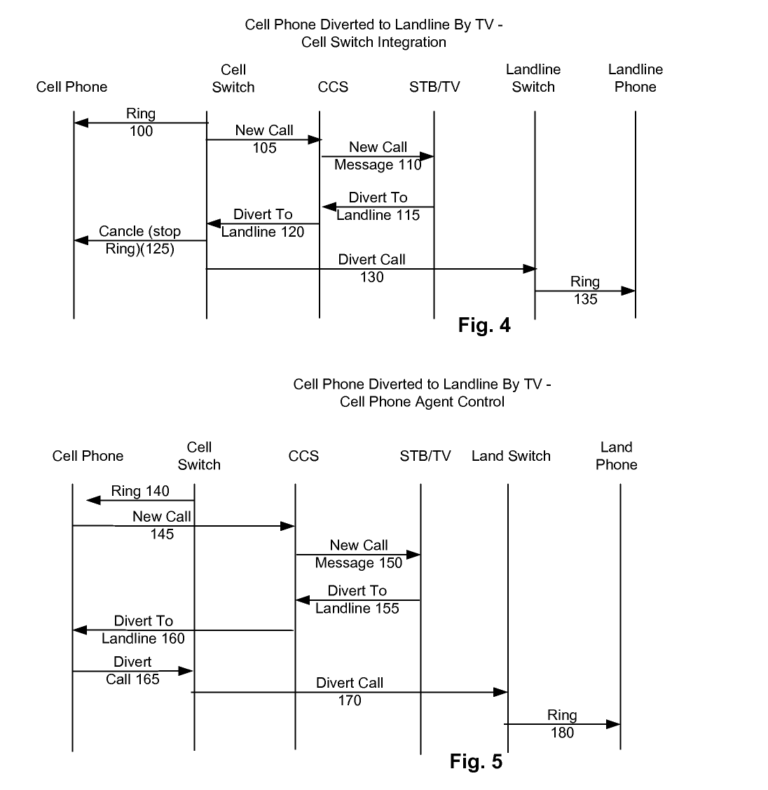

FIG. 4 depicts ordered event flow in a typical divert session in accordance with an embodiment of the invention. In this case a call to a cell phone is diverted to landline phone. The diversion control is done using an STB 670 as the controlling device. The CCS 300 is in communications with the cell phone switch 750. The sequence originates when a new call arrives at the cell switch. The Cell switch rings 100 the Cell phone and sends a new call message 105 to the CCS. Inside the CCS the message is received by the telephony network dispatcher 305 and parsed by the call info and status receiver 310. The correlator 330 is implementing logic that enables it to decide what to do with the information and sends the information to the display generator 350 together with information of the desired target device. Display generator 350 generates a new call message in suitable format for the STB. The TRX coupling equipment dispatcher 500 sends a new call message 110 to the STB / TV using any appropriate protocol. The example assumes that the subscriber desires to divert the call to a landline. Upon user request the STB/TV sends A Divert To Landline 115 command to the CCS. The CCS sends a Divert To Landline 120 command to the Cell Switch. Inside the CCS the message is routed from the TRX coupling equipment dispatcher 500 to the user command receiver 360 which parses the message and transfers it to the user command correlator 340. User command correlator 340 checks the received message and if needed uses the current state of the call and the state of the related devices and decides which command should be sent and to which device and what should be next step or steps. The current state of the call and of the devices can be store in the database or in temporary session on the server. Other possible implementation calls for sending the state information in the messages flowing between and the agents. The agent makes a decision about the next step in handling the call. The decision of the next step is based on the currently received message and if needed the current state of end user device. The state of the end user device can be stored in the database or in temporary storage or sent inside the messages body. In this example, the correlator sends a call control command to the call control commands generator 320 which sends the command via the phone data link 307 to telephony network dispatcher 305, which in turn sends the command to the cell switch that handles the call. The cell Switch sends a Cancel (stop ring) 125 message to the cell Phone and divert the call 130 to the Landline switch. The landline switch rings 135 the Landline phone.

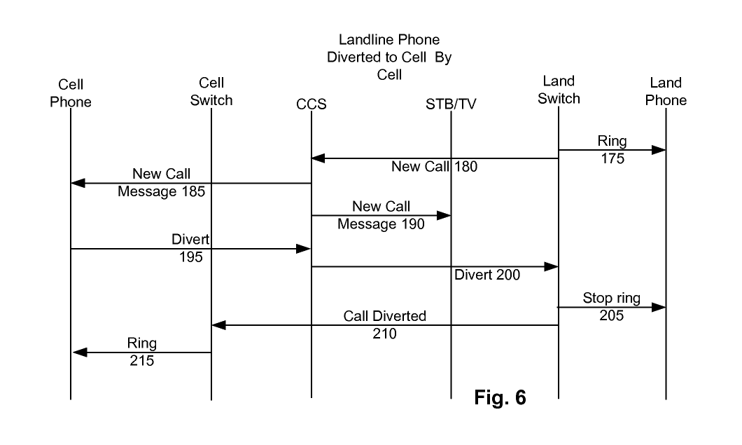

FIG. 5. Is very similar to FIG. 4 but in this case the CCS is communicating with the cell phone agent 710 instead of receiving the call related information from the cell phone switch 750. The sequence originates when a new call arrives to the cell switch, the cell switch rings 140 the cell phone. The cell phone agent sends a new call message 145 to the CCS. The CCS sends a new call message 150 to the STB/TV. Upon user request the STB/TV sends A divert to Landline 155 command to the CCS. The CCS sends a divert to landline 160 command to the cell phone agent. The cell phone agent sends a divert call 165 to the cell switch. The cell switch diverts the call 170 to the landline switch. The landline switch Rings 180 the Landline phone.

FIG. 6 depicts ordered event flow in another typical session in accordance with an embodiment of the invention. This case describes the call flow of a diversion of a call from a landline phone to a cell phone. The agent inside the cell phone or the STB/TV can control the diversion of the call. The sequence originates when a new call arrives to the landline switch, the landline switch rings 175 the landline phone and sends a new call message 180 to the CCS. The CCS sends a new call message 185 to the Cell Phone and to the STB/TV 190. If the user wants to divert the call to the cell phone, the Cell phone sends the divert command 195 to the CCS. Similar command can be sent from the STB/TV. The CCS sends a divert 200 command to the Landline Switch. The Landline switch stops the ring to the landline phone 205 and diverts the call 210 to the Cell Switch. The Cell Switch rings 215 the Cell phone.

Similar flows can be done from advanced phones, cell phones, several phone lines at home and the like. The same method can be used in a case of call waiting instead of new call. Call waiting occurs when a call is attempted to a busy telephone. In such case the waiting call can be diverted to different line.

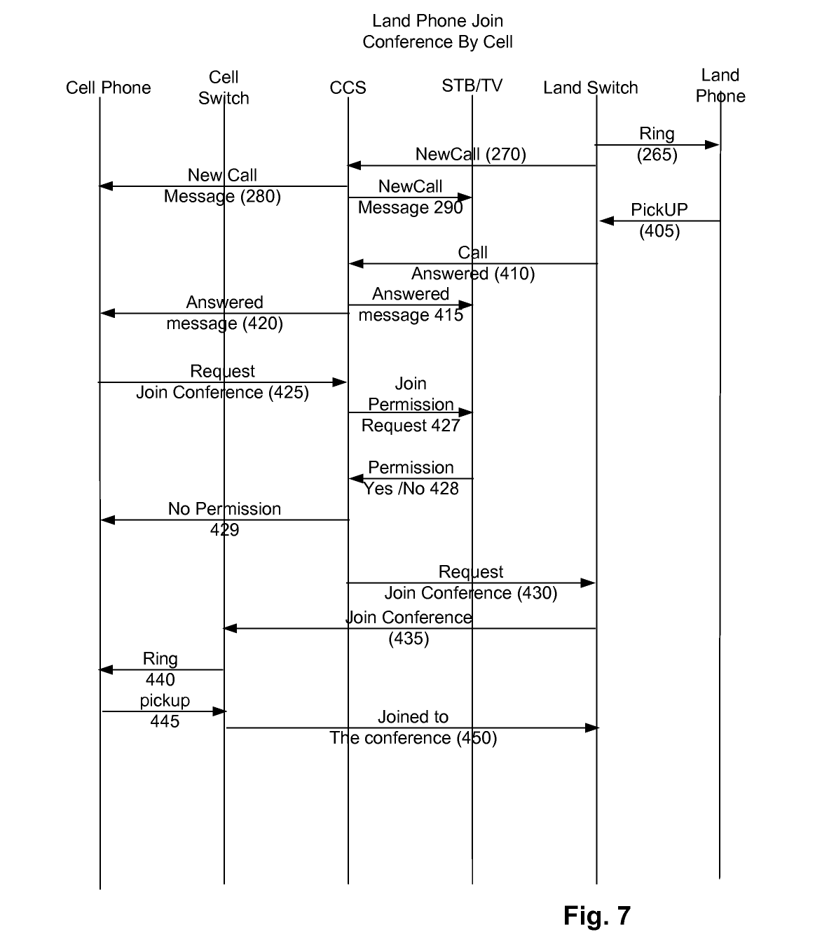

FIG. 7 illustrates the a typical event flow where a cell phone user wants to join to a call that is in progress through a Landline Phone in the system, creating a conference call. When a new call arrives to the landline switch 650, the switch Rings 265 the Landline Phone and generates a New Call message 270 to the CCS 300. The CCS sends New Call Messages to the Cell Phone 280 and to STB/TV 290. The call is answered when the Landline Phone is picked up 405. The Landline switch sends Call Answered 410 message to the CCS. The CCS sends Call Answered messages to the STB/TV 415 and to the Cell Phone 420. When the user of the Cell Phone attempts to join the call, the Cell Phone sends a Request Join Conference 425 to the CCS. Optionally, the CCS may send a Join Permission Request 427 message to the STB/TV. The Landline Phone Subscriber sends a Permission response 428 message to the CCS using the STB/TV.

If the answer to the permission request was negative, the CCS sends a No Permission 429 message back to the Cell Phone and the cell phone session is ended. If the answer to the permission request was affirmative, the CCS sends Request Join Conference 430 to the Landline Switch. The Landline Switch sends Join Conference 435 command to the Cell Switch 750. The Cell Switch rings 440 the Cell Phone, which Pickups 445 the call. The Cell Switch then Join to The conference 450.

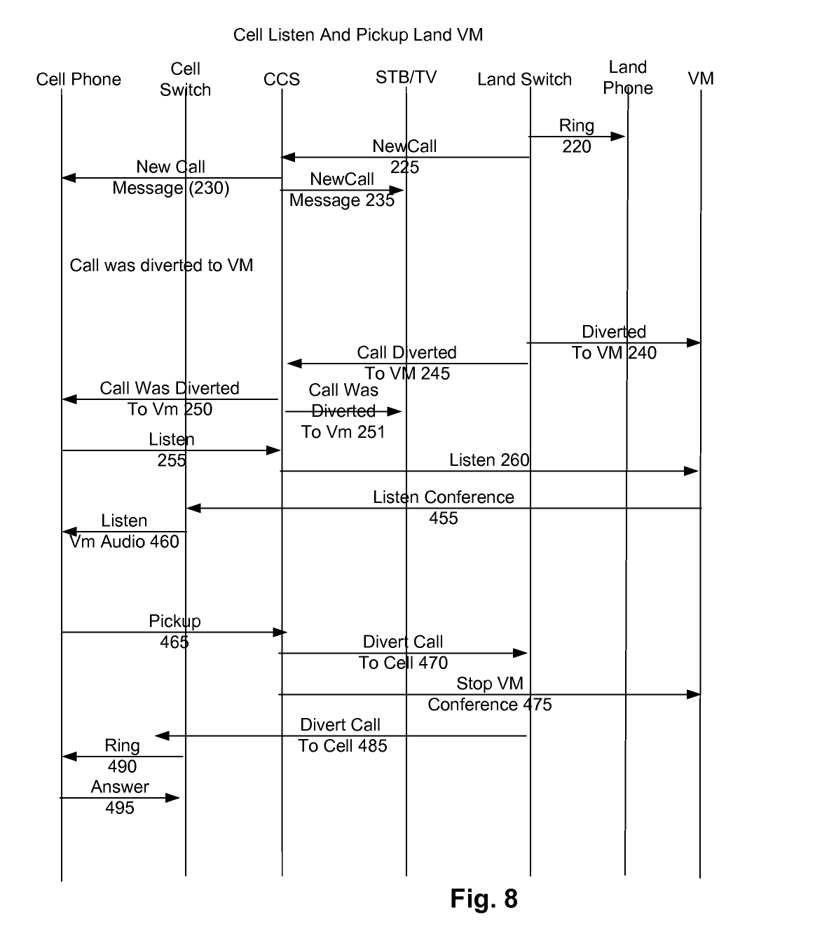

FIG. 8 Illustrates a typical event flow in yet another example, where a subscriber wants to listen to a voice mail while it is being recorded, from a different device. In this case the user uses the Cell Phone to listen to a message that is recorded in the Landline Phone VM. If desired, the user may also pick the call up at the device from which he listens to the message, or divert it to any other device. The same method can be used between any two or more end point devices. The skilled in the art will easily recognize the modification that will allow a single end-user device to listen to the message and the call pick-up.

The sequence originates when a new call arrives to the landline switch. The landline switch rings 220 the landline phone and sends a new call message 225 to the CCS 300. The CCS sends a new call message 230 to the Cell Phone and to the STB/TV 235. Either after a predetermined number of rings, as a result of subscriber settings, busy line, as a result of explicit call rejection, or for any reason, the Landline Switch diverts the call to the VM. The Landline Switch sends Diverted To VM 240 command to the VM and sends a Call Diverted To VM 245 message to the CCS. The CCS sends Call Was Diverted To Vm to the Cell Phone 250 and to the STB/TV 251. The Cell Phone user sends a listen 255 command to the CCS. The CCS than issues a Listen 260 command to the VM. The VM generates a Listen Conference 455 with the Cell Switch. The Cell switch begins an audio session with the Cell Phone, which is described by the Listen VM Audio 460 event. If the Cell Phone user wants to pick the call up, the cell phone sends a Pickup 465 command to the CCS. The CCS sends a Divert call to Cell 470 command to the Land Switch and a Stop VM Conference 475 to the VM. If desired, the caller recording the message receives a notice about the transfer before it is affected. The Landline Switch then performs the Divert Call To Cell 485 command. Depending on the connection type between the VM and the Land Switch, the Divert call to Cell 470 command may be sent directly to the VM instead of the Landline Switch. In this case the VM will divert the call to the Cell Switch. The Cell switch Rings 490 the Cell Phone. The Cell phone Answers 495 the call.

It is important to understand that the commands directed at specific components, such as a cell switch, landline switch, VM, and the like do not need to be a single command. Thus, even standard switches may be used by breaking down the command to a series of commands that are basic for every switch to recognize and act upon. Thus by stringing a group of simpler commands to achieve a more complicated command, simple switches may be used, and in some cases even switches that are not aware of the system and its operation.

It will be appreciated that the invention is not limited to what has been described herein above merely by way of example. While there have been described what are at present considered to be the preferred embodiments of this invention, it will be obvious to those skilled in the art that various other embodiments, changes, and modifications may be made therein without departing from the spirit or scope of this invention and that the claims therefore, aim to encompass such changes and modifications as fall within the true spirit and scope of the invention, for which letters patent is applied.

We claim:

1. A method for routing incoming telephony calls between a plurality of telephony connections, each connection comprising at least one telephony capable end device, the method comprising the steps of:
in a call control server:
receiving information about an incoming call directed to a first end device;
using information associated with said first end device, extracting information from a database, the information comprising at least one rule and information about at least a second end device;
formatting at least one message containing information regarding said incoming call, into a format compatible with said second end device;
transmitting said message to said second end device;
receiving a divert request from said second end device; and,
taking action to redirect said incoming call in accordance with said divert request.

2. A method as claimed in claim 1, wherein in said step of extracting, the information comprises a plurality of end devices.

3. A method as claimed in claim 2 wherein said step of transmitting is performed for at least two of said plurality of end devices.

4. A method as claimed in claim 1, wherein said database resides in a location remote to said first end device.

5. A method as claimed in claim 1, wherein said action is taken at least in part, at a telephony switch.

6. A method as claimed in claim 1, wherein said action or a portion thereof, is initiated at said first end device.

7. A method for routing incoming telephony calls between a plurality of telephony connections, each connection comprising at least one telephony capable end device, the method comprising the steps of:
in a call control server:
receiving information about an incoming call directed to a first end device;
using information about said first end device, extracting information from a database, the information comprising at least one rule and information about a plurality of other end devices;
formatting at least one message containing information regarding said incoming call, into format compatible with at least a second end device selected from said plurality of end devices, the message containing sufficient information to allow said second end device to take action to divert said call.

8. A method as claimed in claim 7, wherein said database resides externally to said first end device.

9. A method as claimed in claim 7, wherein said action to divert the call is initiated by said second end device, and is carried out at a telephony switch remote from said second end device.

10. A telephony call control server comprising:
an incoming call information receiver, constructed to receiving call information regarding an incoming call from a plurality of telephony networks and from a plurality of network types, said information including at least identification of a first end device;
a database manager, constructed to extract from a database related information associated with an incoming call, according to said identification of said first end device, said related information comprising identification of a plurality of other end devices associated with said first end device;
a message formatter, constructed to format a message containing at least said call information, in a format compatible with at least a second end device, selected from said plurality of end devices;
a message transmitter capable of transmitting said message to said second device.

11. The call control server of claim 10, further comprising
a diverter capable of receiving a divert command from said second end device, and initiate action to divert said incoming call in accordance with said divert command.
